(19) United States
(12) Patent Application Publication
(10) Pub. No.: US 2025/0274255 A1
(43) Pub. Date: Aug. 28, 2025

(54) FREQUENCY DOMAIN RESOURCE DETERMINATION METHOD, TERMINAL, AND NETWORK SIDE DEVICE

(71) Applicant: VIVO MOBILE COMMUNICATION CO., LTD., Dongguan (CN)

(72) Inventor: Zhi LU, Dongguan (CN)

(73) Assignee: VIVO MOBILE COMMUNICATION CO., LTD., Dongguan (CN)

(21) Appl. No.: 19/208,565

(22) Filed: May 14, 2025

Related U.S. Application Data
(63) Continuation of application No. PCT/CN2023/128608, filed on Oct. 31, 2023.

(30) Foreign Application Priority Data
Nov. 15, 2022 (CN) 202211432495.6

(51) Int. Cl. H04L 5/00; H04W 72/0453

(52) U.S. Cl. CPC H04L 5/0098; H04W 72/0453

(57) ABSTRACT

A frequency domain resource determination method, a terminal, and a network side device are provided. The frequency domain resource determination method includes: determining, by a terminal, available PRBs in a first RBG in a first mode or a second mode, where at least one PRB in the first RBG overlaps with a first subband or a GB, and a transmission direction of the first subband is different from a transmission direction of the first RBG; the first mode includes: determining the available PRBs in the first RBG according to the first subband or the GB; and the second mode includes: determining the available PRBs in the first RBG according to indication information; and performing, by the terminal, information transmission on the available PRBs in the first RBG, where the first RBG is configured or scheduled to the terminal.

### CROSS-REFERENCE TO RELATED APPLICATIONS

This application is a continuation of International Application No. PCT/CN2023/128608, filed Oct. 31, 2023, which claims priority to Chinese Patent Application No. 202211432495.6, filed Nov. 15, 2022. The entire contents of each of the above-referenced applications are expressly incorporated herein by reference.

### TECHNICAL FIELD

This application belongs to the field of communication technologies, and in particular, relates to a frequency domain resource determination method, a terminal, and a network side device.

### BACKGROUND

For frequency domain resource assignment that uses a Resource Block Group (RBG) as a granularity, the size of the RBG is related to the size of a Band Width Part (BWP), and a network side device may configure a terminal to use one of two RBG size configurations through Radio Resource Control (RRC) signaling.

When an Uplink (UL) subband is configured in a Downlink (DL) BWP, due to the existence of the uplink subband or a Guard Band (GB), at least one RBG in the downlink BWP may be affected by the uplink subband or the GB. If the terminal and the network side device cannot use these affected RBGs, the resource utilization rate will be reduced.

### SUMMARY

Embodiments of this application provide a frequency domain resource determination method, a terminal, and a network side device.

According to a first aspect, a frequency domain resource determination method is provided, including: determining, by a terminal, available Physical Resource Block (PRB) in a first RBG in a first mode or a second mode, where at least one PRB in the first RBG overlaps with a first subband and/or a GB, and a transmission direction of the first subband is different from a transmission direction of the first RBG; the first mode includes: determining the available PRBs in the first RBG according to the first subband and/or the GB; and the second mode includes: determining the available PRBs in the first RBG according to indication information; and performing, by the terminal, information transmission on the available PRBs in the first RBG, where the first RBG is semi-statically configured or dynamically scheduled to the terminal (hereinafter collectively referred to as “configured or scheduled” for brevity).

According to a second aspect, a frequency domain resource determination method is provided, including: sending, by a network side device, indication information, where the indication information is used for indicating available PRBs in a first RBG, where at least one PRB in the first RBG overlaps with a first subband and/or a GB, and a transmission direction of the first subband is different from a transmission direction of the first RBG; and performing, by the network side device, information transmission on the available PRBs in the first RBG, where the first RBG is configured or scheduled to the terminal.

According to a third aspect, a frequency domain resource determination apparatus is provided, including: a determination module, configured to determine available PRBs in a first RBG in a first mode or a second mode, where at least one PRB in the first RBG overlaps with a first subband and/or a GB, and a transmission direction of the first subband is different from a transmission direction of the first RBG; the first mode includes: determining the available PRBs in the first RBG according to the first subband and/or the GB; and the second mode includes: determining the available PRBs in the first RBG according to indication information; and a transmission module, configured to perform information transmission on the available PRBs in the first RBG, where the first RBG is configured or scheduled to the apparatus.

According to a fourth aspect, a frequency domain resource determination apparatus is provided, including: a transmission module, configured to send indication information, where the indication information is used for indicating available PRBs in a first RBG, where at least one PRB in the first RBG overlaps with a first subband and/or a GB, and a transmission direction of the first subband is different from a transmission direction of the first RBG; and the transmission module is further configured to perform information transmission on the available PRBs in the first RBG, where the first RBG is configured or scheduled to the terminal.

According to a fifth aspect, a terminal is provided. The terminal includes a processor and a memory. The memory stores a program or an instruction executable on the processor, and when the program or instruction is executed by the processor, the steps of the method according to the first aspect are implemented.

According to a sixth aspect, a terminal is provided. The terminal includes a processor and a communication interface, where the processor is configured to determine available PRBs in a first RBG in a first mode or a second mode, where at least one PRB in the first RBG overlaps with a first subband and/or a GB, and a transmission direction of the first subband is different from a transmission direction of the first RBG; the first mode includes: determining the available PRBs in the first RBG according to the first subband and/or the GB; and the second mode includes: determining the available PRBs in the first RBG according to indication information, where the communication interface is configured to perform information transmission on the available PRBs in the first RBG, where the first RBG is configured or scheduled to the terminal.

According to a seventh aspect, a network side device is provided. The network side device includes a processor and a memory. The memory stores a program or an instruction executable on the processor, and when the program or instruction is executed by the processor, the steps of the method according to the second aspect are implemented.

According to an eighth aspect, a network side device is provided. The network side device includes a processor and a communication interface, where the communication interface is configured to send indication information, where the indication information is used for indicating available PRBs in a first RBG, where at least one PRB in the first RBG overlaps with a first subband and/or a GB, and a transmission direction of the first subband is different from a transmission direction of the first RBG; and perform information transmission on the available PRBs in the first RBG, where the first RBG is configured or scheduled to the terminal.

According to a ninth aspect, a frequency domain resource determination system is provided, including: a terminal and a network side device. The terminal may be configured to perform the steps of the method according to the first aspect, and the network side device may be configured to perform the steps of the method according to the second aspect.

According to a tenth aspect, a readable storage medium is provided. The readable storage medium stores a program or an instruction. When the program or instruction is executed by a processor, the steps of the method according to the first aspect are implemented, or the steps of the method according to the second aspect are implemented.

According to an eleventh aspect, a chip is provided, including a processor and a communication interface. The communication interface is coupled to the processor. The processor is configured to run a program or an instruction to implement the steps of the method according to the first aspect, or implement the steps of the method according to the second aspect.

According to a twelfth aspect, a computer program/program product is provided. The computer program/program product is stored in a storage medium. The computer program/program product is executed by at least one processor to implement the steps of the method according to the first aspect, or implement the steps of the method according to the second aspect.

In the embodiments of this application, in a case that at least one PRB in the first RBG overlaps with the first subband and/or the GB, and the transmission direction of the first subband is different from the transmission direction of the first RBG, the terminal may determine the available PRBs in the first RBG according to the first subband and/or the GB or according to the indication information. In this way, the terminal can perform information transmission on the available PRBs in the first RBG. In the embodiments of this application, the PRBs in the first RBG can be fully used, which is favorable for improving the utilization rate of frequency domain resources. In addition, in the embodiments of this application, the full-duplex configuration of different service requirements in an NR can be met, which is favorable for improving the system resource utilization rate and reducing the time delay.

### BRIEF DESCRIPTION OF THE DRAWINGS

FIG. 1 is a schematic diagram of a wireless communication system according to an embodiment of this application;

FIG. 2 is a schematic flowchart of a frequency domain resource determination method according to an embodiment of this application;

FIG. 3 is a schematic diagram of application of a frequency domain resource determination method according to an embodiment of this application;

FIG. 4 is a schematic diagram of application of a frequency domain resource determination method according to an embodiment of this application;

FIG. 5 is a schematic diagram of application of a frequency domain resource determination method according to an embodiment of this application;

FIG. 6 is a schematic diagram of application of a frequency domain resource determination method according to an embodiment of this application;

FIG. 7 is a schematic diagram of application of a frequency domain resource determination method according to an embodiment of this application;

FIG. 8 is a schematic flowchart of a frequency domain resource determination method according to an embodiment of this application;

FIG. 9 is a schematic structural diagram of a frequency domain resource determination apparatus according to an embodiment of this application;

FIG. 10 is a schematic structural diagram of a frequency domain resource determination apparatus according to an embodiment of this application;

FIG. 11 is a schematic structural diagram of a communication device according to an embodiment of this application;

FIG. 12 is a schematic structural diagram of a terminal according to an embodiment of this application; and

FIG. 13 is a schematic structural diagram of a network side device according to an embodiment of this application.

### DETAILED DESCRIPTION

The technical solutions in the embodiments of this application are clearly described in the following with reference to the accompanying drawings in the embodiments of this application. Apparently, the described embodiments are merely some rather than all of the embodiments of this application. Based on the embodiments of this application, all other embodiments obtained by a person of ordinary skill in the art fall within the protection scope of this application.

In the specification and claims of this application, the terms such as “first” and “second” are used for distinguishing similar objects, rather than describing a specific sequence or order. It should be understood that the terms used in this way are exchangeable in a proper case, so that the embodiments of this application may be implemented in sequences different from the sequences shown or described herein. Moreover, objects distinguished by “first” and “second” are usually of the same category, and the number of the objects is not limited. For example, there may be one or more first objects. In addition, the expression “and/or” in the specification and claims represents at least one of connected objects, and the character “/” generally represents that the associated objects are in an “or” relationship.

It should be noted that the technology described in the embodiments of this application is not limited to a Long Term Evolution (LTE)/LTE-Advanced (LTE-A) system, but may be further used in other wireless communication systems, such as Code Division Multiple Access (CDMA), Time Division Multiple Access (TDMA), Frequency Division Multiple Access (FDMA), Orthogonal Frequency Division Multiple Access (OFDMA), Single-carrier Frequency Division Multiple Access (SC-FDMA), and other systems. The terms “system” and “network” in the embodiments of this application are usually interchangeably used, and the technologies described may be applied to the systems and radio technologies mentioned above, and may also be applied to other systems and radio technologies. The following descriptions describe a New Radio (NR) system for illustration, and NR terms are used in most of the following descriptions, but these technologies may also be applied to applications other than NR system applications, such as 6th Generation (6G) communication systems.

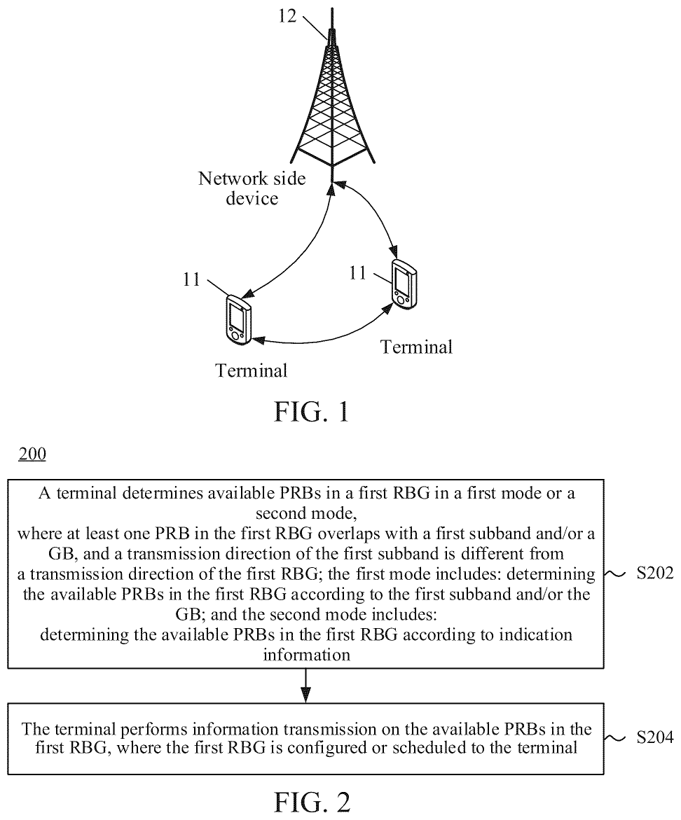

FIG. 1 shows a block diagram of a wireless communication system to which an embodiment of this application can be applied. The wireless communication system includes a terminal 11 and a network side device 12. The terminal 11 may be a terminal side device such as a mobile phone, a tablet personal computer, a laptop computer, which is also referred to as a notebook computer, a Personal Digital Assistant (PDA), a palm computer, a netbook, an ultra-mobile personal computer (UMPC), a mobile Internet device (MID), an augmented reality (AR)/virtual reality (VR) device, a robot, a wearable device, vehicle user equipment (VUE), pedestrian user equipment (PUE), smart home (a home device with a wireless communication function, such as a refrigerator, a television, a washing machine, or furniture), a game console, a personal computer (PC), a teller machine, or a self-service machine. The wearable device includes: a smart watch, a smart band, a smart headset, smart glasses, smart jewelry (a smart bracelet, a smart hand chain, a smart ring, a smart necklace, a smart bangle, a smart anklet, and the like), a smart wrist strap, a smart dress, and the like. It should be noted that the specific type of the terminal 11 is not limited in the embodiment of this application. The network side device 12 may include an access network device or a core network device. The access network device may also be referred to as a radio access network device, a Radio Access Network (RAN), a radio access network function, or a radio access network unit. The access network device may include a base station, a Wireless Local Area Network (WLAN) access point, a Wireless Fidelity (WiFi) node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmission Reception Point (TRP), or another proper term in the art. As long as the same technical effect is achieved, the base station is not limited to a specific technical vocabulary. It should be noted that in the embodiment of this application, a base station in an NR system is taken only as an example for introduction, but the specific type of the base station is not limited.

Frequency domain resource determination methods provided in embodiments of this application are described in detail below through some embodiments and application scenarios thereof with reference to the accompanying drawings.

As shown in FIG. 2, an embodiment of this application provides a frequency domain resource determination method 200. The method may be executed by a terminal. In other words, the method may be executed by software or hardware installed in the terminal. The method includes the following steps:

S202: The terminal determines available Physical Resource Block (PRB) in a first Resource Block Group (RBG) in a first mode or a second mode, where at least one PRB in the first RBG overlaps with a first subband and/or a Guard Band (GB), and a transmission direction of the first subband is different from a transmission direction of the first RBG; the first mode includes: determining the available PRBs in the first RBG according to the first subband and/or the GB; and the second mode includes: determining the available PRBs in the first RBG according to indication information.

The embodiment of this application may be applied to a non-overlapping subband full duplex (SBFD) scenario. The first RBG may be located in a downlink BWP, the first subband may be an uplink subband, that is, the uplink subband is configured in a downlink carrier, and a transmission direction of the first subband is different from (that is, opposite to) a transmission direction of the first RBG; or, the first RBG may be located in an uplink BWP, the first subband is a downlink subband, that is, the downlink subband is configured in an uplink carrier, and a transmission direction of the first subband is different from (that is, opposite to) a transmission direction of the first RBG.

In this embodiment, the network side device may indicate the terminal that the frequency resource assignment is based on the RBG granularity. This embodiment is applicable to scheduling of the frequency resource assignment type 0 with the RBG as the granularity, or may be applicable to scheduling of the frequency resource assignment type 1 with the RBG as the granularity.

In this embodiment, at least one PRB in the first RBG overlaps with the first subband and/or the GB, or the first RBG is affected by the first subband and/or the GB. For example, the first RBG includes four PRBs which are respectively a PRB1, a PRB2, a PRB3, and a PRB4. The PRB3 is configured as the GB, and the PRB4 is configured as a part of the first subband. In this case, the PRB3 and the PRB4 respectively overlap with the GB and the first subband.

In some embodiments, before S202, the network side device may configure the frequency domain position and size of the first subband and the frequency domain position and size of the GB; or, the network side device configures the frequency domain position and size of the first subband and the size of the GB, where the GB may be located at two ends of the first subband by default; or, the terminal implicitly determines the frequency domain position and size of the GB according to the frequency domain position and size of the first subband.

In this embodiment, in a case that the first RBG is configured or scheduled, the terminal may determine the available PRBs in the first RBG in the first mode or the second mode.

The first mode, that is, the determining the available PRBs in the first RBG according to the first subband and/or the GB includes: determining the available PRBs in the first RBG according to the first subband and/or the GB. In some embodiments, the terminal determines PRBs in the first RBG other than the PRBs that overlap with the first subband and/or the GB as the available PRBs. For example, the first RBG includes four PRBs which are respectively a PRB1, a PRB2, a PRB3, and a PRB4. The PRB3 is configured as the GB, and the PRB4 is configured as a part of the first subband. In this case, the PRB3 and the PRB4 respectively overlap with the GB and the first subband, and the terminal determines that the PRB1 and the PRB2 are available PRBs.

The second mode includes: determining the available PRBs in the first RBG according to indication information. In this embodiment, the terminal may receive indication information from the network side device, and the indication information is used for indicating the available PRBs in the first RBG. For example, the first RBG includes four PRBs which are respectively a PRB1, a PRB2, a PRB3, and a PRB4. The PRB3 is configured as the GB, and the PRB4 is configured as a part of the first subband. In this case, the PRB3 and the PRB4 respectively overlap with the GB and the first subband. If the frequency domain resource assignment indicated by the network side device to the terminal through the indication information includes the first RBG, only the PRB1 and the PRB2 in the first RBG are available PRBs, and the PRB3 and the PRB4 are unavailable.

In some embodiments, the network side device may use user equipment (UE) specific signaling and/or UE common signaling, and configure the terminal to use the first mode or the second mode per slot or sub-slot. Embodiment 200 further includes the following step: the terminal receives UE specific signaling and/or UE common signaling, where the UE specific signaling and/or the UE common signaling are/is used for configuring the terminal to use the first mode or the second mode according to the granularity of a slot or a sub-slot.

In some embodiments, the network may dynamically indicate whether the first mode or the second mode is used for uplink scheduling or downlink scheduling. Embodiment 200 further includes the following step: the terminal receives dynamic indication signaling, where the dynamic indication signaling is used for indicating the terminal to determine the available PRBs in the first RBG in the first mode or the second mode, and the first RBG is located in a scheduled resource.

S204: The terminal performs information transmission on the available PRBs in the first RBG, where the first RBG is configured or scheduled to the terminal.

In this step, the information transmitted by the terminal may include data, control information, or the like.

In this embodiment, in a case that the first RBG is a downlink resource, the terminal may receive information on the available PRBs in the first RBG, for example, receive a Physical Downlink Shared Channel (PDSCH) or a Physical Downlink Control Channel (PDCCH). In a case that the first RBG is an uplink resource, the terminal may send information on the available PRBs in the first RBG, for example, send a Physical Uplink Shared Channel (PUSCH) or a Physical Uplink Control Channel (PUCCH).

According to the frequency domain resource determination method provided in the embodiment of this application, in a case that at least one PRB in the first RBG overlaps with the first subband and/or the GB and the transmission direction of the first subband is different from the transmission direction of the first RBG, the terminal may determine the available PRBs in the first RBG according to the first subband and/or the GB or according to the indication information. In this way, the terminal may perform information transmission on the available PRBs in the first RBG. In the embodiment of this application, the PRBs in the first RBG can be fully used, which is favorable for improving the utilization rate of frequency domain resources. In addition, in the embodiment of this application, the full-duplex configuration of different service requirements in an NR can be met, which is favorable for improving the system resource utilization rate and reducing the time delay.

The first mode introduced in Embodiment 200 may include: determining PRBs in the first RBG other than the PRBs that overlap with the first subband and/or the GB as the available PRBs. In this example, the terminal determines the available PRBs in the first RBG according to an implicit indication.

In this embodiment, for example, when the network side device indicates to schedule at least one RBG affected by an uplink subband (UL subband) and/or the GB, that is, at least one PRB corresponding to the RBG overlaps with the frequency domain of the UL subband and/or the GB, the terminal determines an available RB in the affected RBG according to the frequency domain position of the UL subband and/or the GB. For example, a remaining PRB in an RBG that is obtained after the PRBs overlapping with the frequency domain of the UL subband and/or the GB are excluded is used as the available PRBs. For a specific example, reference can be made to Embodiment 1 below.

The following introduces an implementation of the indication information of the second mode in Embodiment 200 by multiple embodiments.

In an example, the indication information includes a first bit field, and the method further includes: the terminal determines the bit number of the first bit field according to the number of second RBGs, where the second RBG is located in a BWP in which the first RBG is located, and all PRBs of the second RBG overlap with the first subband.

In this embodiment, for example, one bit number is determined according to the number of RBGs (that is, second RBGs) in the DL BWP where any one PRB has frequency-domain overlapping with the UL subband, and any PRB in the second RBG has frequency-domain overlapping with the UL subband, so that the second RBG cannot be assigned to the PDSCH. These bits may be used for indicating available PRBs or unavailable PRBs in the first RBG (that is, having frequency-domain overlapping with the GB or the UL subband) indicated by the Frequency Domain Resource Assignment (FDRA) of the PDSCH. The terminal receives the PDSCH on the available PRBs in these indicated RBGs. For a specific example, reference can be made to Embodiment 2 below.

In this embodiment, the number of available PRBs in the first RBG is less than or equal to the bit number of the first bit field, where one bit of the first bit field indicates one available PRB. In this embodiment, the terminal expects that the number of available PRBs in the first RBG is less than the bit number of the first bit field. For a specific example, reference can be made to Embodiment 3 below.

In this embodiment, the number of available PRBs in the first RBG is greater than the bit number of the first bit field, where one bit of the first bit field indicates X available PRBs, X is a positive integer, and X≥2. In some embodiments, the first bit field further includes bit information for indicating X.

In this embodiment, if the number of available PRBs in the first RBG is greater than the bit number of the first bit field, the network side device may configure the first bit field to indicate the available PRBs in the first RBG by using an X RB as the granularity. For a specific example, reference can be made to Embodiment 4 below. In some embodiments, first N bits of the first bit field may indicate an indication granularity X.

In some embodiments, that the terminal determines the bit number of the first bit field according to the number of second RBGs includes: determining, by the terminal, the bit number of the first bit field according to the number of second RBGs and the size of the GB. For example, the terminal determines (according to the granularity of the DL RBG) a bit number according to both the size of the UL subband and the size of the GB, and these bits may be used for indicating the available PRBs in the first RBG. For a specific example, reference can be made to Embodiment 5 below.

In another example, the indication information in Downlink Control Information (DCI) includes a mapping relationship, and the second mode includes: determining the available PRBs in the first RBG according to the mapping relationship and a first element set, where the first element set includes a corresponding relationship with the number of a plurality of available PRBs and may be configured by the network. In this embodiment, the network side device configures a table corresponding to K bits to indicate the available PRBs in the first RBG, and additionally adds K bits to the DCI to indicate these available PRBs. For a specific example, reference can be made to Embodiment 7 below.

In still another example, the indication information includes bitmap information, the bitmap information is used for indicating the available PRBs in the first RBG, and the bitmap information may be located in the DCI. In this embodiment, the network configures an additional bit in the DCI, and uses a bitmap to indicate the available PRBs in the first RBG. For a specific example, reference can be made to Embodiment 8 below.

In each of the foregoing embodiments, before the terminal determines the available PRBs in the first RBG in the first mode or the second mode, the method further includes one of the following: the terminal determines one of the following: (1) the frequency domain position and size of the first subband and the frequency domain position and size of the GB; or (2) the frequency domain position and size of the first subband and the size of the GB; or the terminal implicitly determines the frequency domain position and size of the GB according to the frequency domain position and size of the foregoing first subband, where the frequency domain position and size of the GB are implicitly determined according to the frequency domain position and size of the first subband.

To describe the frequency domain resource determination method provided in the embodiments of this application in detail, the following description will be made with reference to several specific embodiments.

### Embodiment 1

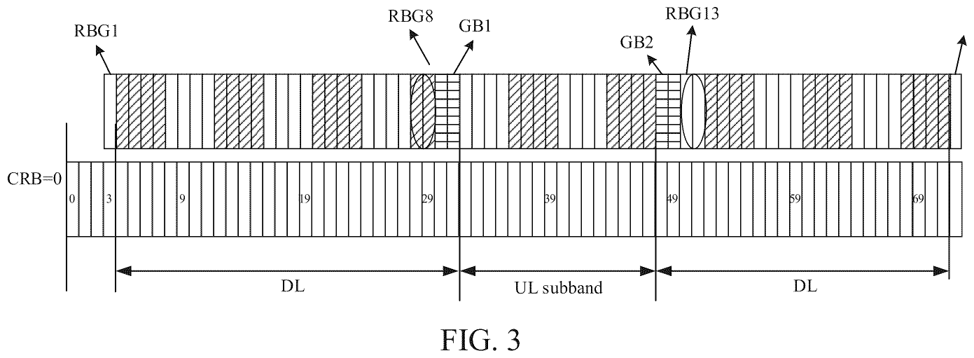

As shown in FIG. 3, in this embodiment, for example, the BWP bandwidth is 70 PRBs, a starting PRB is 3 (relative to common PRB-common PRB), and the network configures the RBG granularity as 4.

The BWP is divided into 19 RBGs, where a first RBG (RBG1) and a last RBG (RBG19) only have one PRB, and the remaining RBGs include four PRBs.

The network configures frequency domain positions of a UL subband as a PRB32 to a PRB47, a total of 16 PRBs.

The network configures the size and frequency domain position of a GB in carrier level signaling, UL subband signaling, or DL BWP signaling.

For example, the GB includes PRBs adjacent to the UL subband. GB: {size 1 (lower frequency), size 2 (higher frequency)}. GB in an example of FIG. 3: {2, 2} indicates that two PRBs to the left of an edge PRB31 of the UL subband are used as the GB, and two PRBs to the right of an edge PRB47 of the UL subband are used as the GB. In this way, adjacent to the UL subband, two PRBs at a low frequency and two PRBs at a high frequency are used as the GB.

For another example, the GB includes PRBs adjacent to the UL subband. GB: {0, . . . , 273} indicates, in a bitmap form, which PRBs are used as the GB. For example, bits at positions 30, 31, 48, and 49 are 1. This indicates that the four PRBs are used as the GB.

For another example, the network may configure the frequency domain position and size of a DL subband, and also configure the frequency domain position and size of the UL subband to implicitly determine the frequency and size of the GB. A DL subband 1 ranges from a PRB3 to a PRB29, a DL subband 2 ranges from a PRB50 to a PRB72, and the frequency domain position of the UL subband ranges from a PRB32 to a PRB47. Therefore, it can be implicitly determined that the GB includes PRBs 30, 31, 48, and 49.

When a gNB indicates that the frequency resource granularity is based on the RBG, for an RBG overlapping with the GB, UE determines that an available RB in the RBG may be used for actual scheduling. For example, when the gNB indicates that an RBG8 and an RBG13 are assigned to one UE, the two RBGs each only have two RBs available for transmission. Ellipses in FIG. 3 indicate actual available PRBs in the scheduled RBG.

The UE receives a PDSCH on the RBG indicated by the network and the available PRBs in the indicated RBG.

This embodiment may be applied to a resource assignment type 0, or may be applied to a resource assignment type 1 using the RBG as the granularity.

### Embodiment 2

Taking FIG. 3 as an example, a frequency-domain PRB of the UL subband corresponds to four RBGs (RBG9, 10, 11, and 12) in a DL BWP. These UL subbands are not used for DL scheduling. Therefore, for DL scheduling, 4 bits corresponding to the four RBGs (corresponding to the foregoing second RBG) may be used for indicating partially available RBs within RBGs overlapping with the UL subband or the GB.

When the network schedules the RBG8 and/or the RBG13, the bit number corresponding to the RBG9 to the RBG12 may be used for indicating PRBs corresponding to the RBG8 and the RBG13.

In the RBG8, a PRB28 and a PRB29 are available PRBs. In the RBG13, a PRB50 and a PRB51 are available PRBs. The network may configure a corresponding relationship between the bit corresponding to the RBG in the DL BWP in the UL subband and the available RB in the RBG overlapping with the UL subband or the GB, that is, a bit sequence and a PRB sequence.

One corresponding relationship is that PRBs are sequentially indicated from a low frequency to a high frequency, as shown in the following table (or may be sequentially indicated from a high frequency to a low frequency).

| | |
|---|---|
| bit corresponding to RBG | Indicate available RB in RBG |
| in DL BWP corresponding | overlapping with UL |
| to UL subband | subband or GB |
| bit corresponding to RBG9 | PRB28 in RBG8 |
| in DL BWP corresponding | |
| to UL subband | |
| bit corresponding to RBG10 | PRB29 in RBG8 |
| in DL BWP corresponding | |
| to UL subband | |
| bit corresponding to RBG11 | PRB50 in RBG13 |
| in DL BWP corresponding | |
| to UL subband | |
| bit corresponding to RBG12 | PRB51 in RBG13 |
| in DL BWP corresponding | |
| to UL subband | |

One corresponding relationship is that the PRB polling indication starts from a low frequency (or from a high frequency) and starts from a PRB far away from the UL subband or the GB to a PRB close to the UL subband or the GB, as shown in the following table:

| | |
|---|---|
| bit corresponding to RBG | Indicate available RB |
| in DL BWP corresponding | in RBG overlapping |
| to UL subband | with UL subband or GB |
| bit corresponding to RBG9 | PRB28 in RBG8 |
| in DL BWP corresponding | |
| to UL subband | |
| bit corresponding to RBG10 | PRB51 in RBG13 |
| in DL BWP corresponding | |
| to UL subband | |
| bit corresponding to RBG11 | PRB29 in RBG8 |
| in DL BWP corresponding | |
| to UL subband | |
| bit corresponding to RBG12 | PRB50 in RBG13 |
| in DL BWP corresponding | |
| to UL subband | |

### Embodiment 3

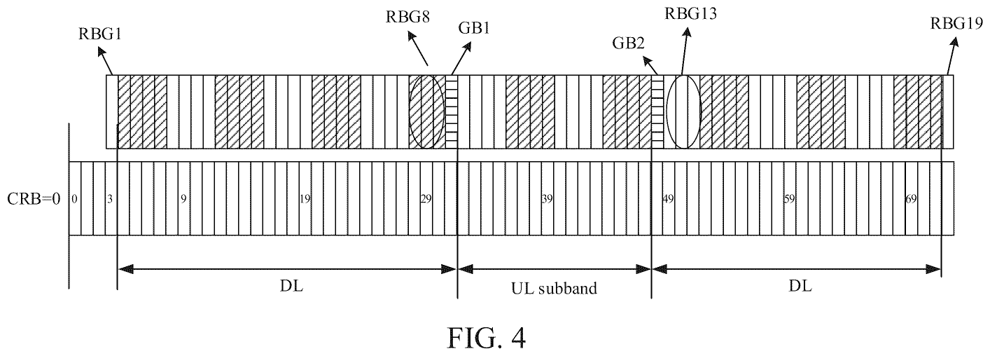

A rule is defined as follows: the UE expects that the number of available PRBs in the incomplete RBG (that is, the first RBG) caused by the UL subband or the GB is less than the bit number (that is, the bit number of the first bit field) determined according to the UL subband, that is, the situation in FIG. 4 is not expected by the UE.

In FIG. 4, ellipses in FIG. 4 indicate actual available PRBs. The GB has one PRB on each of two sides of the UL subband, the number of RBGs (the number of available bits) in the DL BWP corresponding to the UL subband is four, and the number of available PRBs in the PRG overlapping with the GB (or the UL subband) is six (the RBG8 has three available PRBs, and the RBG13 has three available PRBs).

### Embodiment 4

As shown in FIG. 4, the number of available PRBs in the RBG overlapping with the GB, that is, the first RBG is greater than the bit number (that is, the bit number of the first bit field) determined according to the UL subband. The network may configure X RB granularity indication. If the indication granularity is configured as 2, a corresponding relationship is from a low frequency to a high frequency (or from a high frequency to a low frequency), as shown in the following table:

| | |
|---|---|
| bit corresponding to RBG | Indicate available RB in RBG |
| in DL BWP corresponding | overlapping withUL subband or GB, |
| to UL subband | having granularity of 2 |
| bit corresponding to RBG9 | PRB28 and PRB29 in RBG8 |
| in DL BWP corresponding | |
| to UL subband | |
| bit corresponding to RBG10 | PRB30 in RBG8, |
| in DL BWP corresponding | and PRB49 in RBG13 |
| to UL subband | |
| bit corresponding to RBG11 | PRB50 and PRB51 in RBG13 |
| in DL BWP corresponding | |
| to UL subband | |
| bit corresponding to RBG12 | Reserved |
| in DL BWP corresponding | |
| to UL subband | |

In some embodiments, indications are provided from both edges of the first PRG frequency to the middle of the frequency, as shown in the following table:

| | |
|---|---|
| bit corresponding to RBG | Indicate available RB in RBG |
| in DL BWP corresponding | overlapping with UL subband or |
| to UL subband | GB, having granularity of 2 |
| bit corresponding to RBG9 | PRB28 in RBG8, and |
| in DL BWP corresponding | PRB51 in RBG13 |
| to UL subband | |
| bit corresponding to RBG10 | PRB29 in RBG8, and |
| in DL BWP corresponding | PRB50 in RBG13 |
| to UL subband | |
| bit corresponding to RBG11 | PRB30 in RBG8, and |
| in DL BWP corresponding | PRB49 in RBG13 |
| to UL subband | |
| bit corresponding to RBG12 | Reserved |
| in DL BWP corresponding | |
| to UL subband | |

In some embodiments, in the bit number determined according to the UL subband, first Y bits indicate the indication granularity. In the following table, an example in which the granularity is indicated by using one bit is used.

| Granularity indication bit | Granularity |
|---|---|
| 0 | 1PRB |
| 1 | 2PRB |

### Embodiment 5

The configuration of the UL subband may not be aligned with the RBG of the DL BWP. That is, one edge or two edges of the UL subband overlap with the first RBG. If the PRBs in the first RBG that are outside the UL subband are located in the GB, a bit field corresponding to the RBG may be used for indicating the available PRBs in the RBG overlapping with the UL subband or the GB. In this case, the UE determines (the band width is based on the granularity of the DL RBG) a bit number according to both the size of the UL subband and the size of (some or all of) the GB. These bits may be used for indicating the available PRBs in the RBG overlapping with the UL subband or the GB.

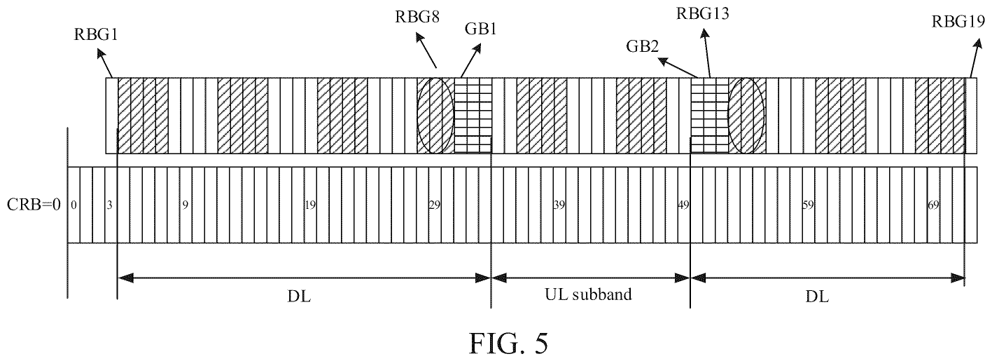

As shown in FIG. 5, the UL subband occupies two RBs in the RBG9 and two RBs in the RBG10, 11 and 12 and the RBG13, the GB1 and the GB2 respectively include three PRBs, and the RBG8 and 14 respectively include three available PRBs. Ellipses in FIG. 5 indicate actual available PRBs.

Method 1: The UE determines occupied bits according to both the size of the UL subband and the size of the GB (based on the granularity of the DL RBG).

The DL RBG indicates occupation of 14 bits (indicating RBG1 to RBG8, and RBG14 to RBG19), and the bit number determined by the size of the UL subband and the size of the GB is 5 bits.

Method 2: If the UE determines the bit available for indicating the RB in the RBG overlapping with the UL subband or the GB according to the size of the complete RBG in the UL subband (the band width is converted according to the granularity of the DL RBG),

the DL RBG indicates occupation of 14 bits (RBG1 to RBG8, and RBG14 to RBG19), and the bit number determined by the complete RBG in the UL subband is 3 bits.

In some embodiments, if the GB outside the UL subband occupies more than one complete RBG, bits corresponding to these RBGs may be used for indicating the available PRBs in the RBG overlapping with the UL subband or the GB, and whether these bits are used may be configured by the network side device.

The two modes may be configured by the network.

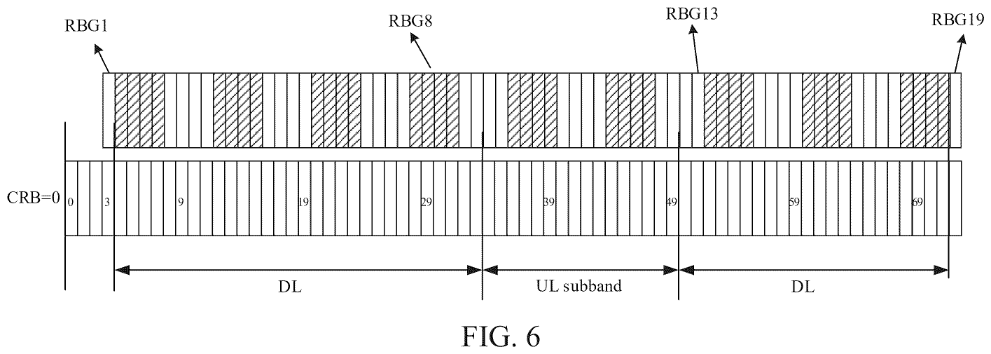

In another embodiment, if the size of the GB is 0, the UE determines that the bit quantities are the same according to the two modes. For example, as shown in FIG. 6:

Method 1: The UE determines occupied bits according to both the size of the UL subband and the size of the GB (the band width is based on the granularity of the DL RBG).

The DL RBG indicates occupation of 16 bits (RBG1 to RBG9, and RBG13 to RBG19), and the bit number determined by the size of the UL subband and the size of the GB is 3 bits. That is, the UL subband and the GB band width correspond to three complete RBGs in the DL BWP.

Method 2: If the UE determines the bit available for indicating the RB in the RBG overlapping with the UL subband or the GB according to the size of the complete RBG in the UL subband (converted according to the granularity of the DL RBG),

the DL RBG indicates occupation of 16 bits (RBG1 to RBG9, and RBG13 to RBG19), and the bit number determined by the complete RBG in the UL subband is 3 bits.

### Embodiment 6

When scheduling the DL frequency domain resource assignment of the UE, the gNB may always not indicate the RBG overlapping with the UL subband or the GB. In this case, only the bit number determined by the UL subband and/or the GB (the band width is converted according to the granularity of the DL RBG) indicates which PRBs are used in the RBG overlapping with the UL subband or the GB. In this case, the bit for indicating the RBG overlapping with the UL subband or the GB may also be used for indicating the available PRBs in the first RBG. Which mode is used may be configured by the network.

### Embodiment 7

The network configures a table corresponding to K bits to indicate the number of available PRBs in the RBG overlapping with the UL subband or the GB, and additionally adds K bits to the DCI to indicate these PRBs. For example, K=2.

The first element set configured by the network may be formed by the following table.

| | Number of available | Number of available |
|---|---|---|
| | PRBs in RBG | PRBs in RBG |
| | overlapping with UL | overlapping with UL |
| Codepoint | subband or GB1 | subband or GB2 |
| 0 | 2 | 2 |
| 1 | 1 | 3 |
| 2 | 3 | 1 |
| 3 | 3 | 3 |

### Embodiment 8

Taking FIG. 3 as an example, the network additionally configures 4 bits during scheduling DCI to indicate the available RB in the RBG overlapping with the UL subband or the GB.

### Embodiment 9

The network may configure whether to use the first mode or the second mode by using UE specific signaling and/or UE common signaling per slot. These slots may be SBFD slots or subsets of SBFD slots.

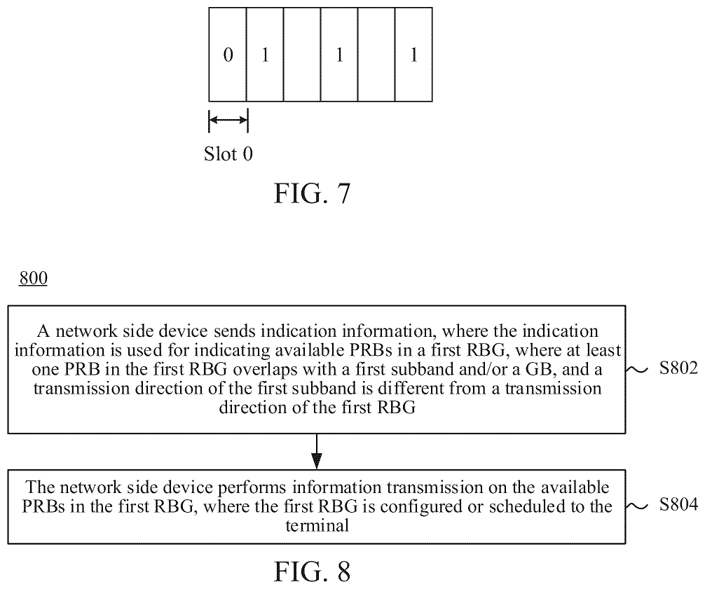

For example, as shown in FIG. 7, the network configures the UE to use the first mode or the second mode in a slot1, a slot3, and a slot5. For a slot that is not indicated, the network may not schedule these RBGs overlapping with the UL subband or the GB.

In some embodiments, the network may configure a starting slot and a continuous period using the first mode or the second mode.

In some embodiments, the network may dynamically indicate whether the first mode or the second mode is used.

A dynamic scheduling method: 1 bit is used in the DCI to indicate that the first mode or the second mode is used. For example, 1 bit of the most important bit field in the FDRA is used for determining whether the first mode or the second mode is used. 1 bit is newly added to indicate whether the first mode or the second mode is used.

### Embodiment 10

The network may configure whether the foregoing indication may be used for indicating the PRBs included in the GB. That is, these bits indicate whether the PRBs in the RBG overlapping with the GB is available for data transmission.

The frequency domain resource determination method according to the embodiments of this application is described in detail above with reference to FIG. 2 to FIG. 7. A frequency domain resource determination method according to another embodiment of this application is described in detail below with reference to FIG. 8. It can be understood that the interaction between a network side device and a terminal described from the perspective of the network side device is the same as or corresponds to that described from the perspective of the terminal side in the method shown in FIG. 2. To avoid repetition, relevant descriptions are appropriately omitted.

FIG. 8 is a schematic flowchart of an implementation of a frequency domain resource determination method according to an embodiment of this application, which may be applied to the network side device. As shown in FIG. 8, the method 800 includes the following steps:

S802: A network side device sends indication information, where the indication information is used for indicating available PRBs in a first RBG, where at least one PRB in the first RBG overlaps with a first subband and/or a GB, and a transmission direction of the first subband is different from a transmission direction of the first RBG.

S804: The network side device performs information transmission on the available PRBs in the first RBG, where the first RBG is configured or scheduled to the terminal.

In the embodiment of this application, in a case that at least one PRB in the first RBG overlaps with the first subband and/or the GB and the transmission direction of the first subband is different from the transmission direction of the first RBG, the network side device may indicate the available PRBs in the first RBG, or may perform information transmission on the available PRBs in the first RBG. In the embodiment of this application, the PRBs in the first RBG can be fully used, which is favorable for improving the utilization rate of frequency domain resources. In addition, in the embodiment of this application, the full-duplex configuration of different service requirements in an NR can be met, which is favorable for improving the system resource utilization rate and reducing the time delay.

In some embodiments, the indication information includes a first bit field, and the bit number of the first bit field is determined according to the number of second RBGs, where the second RBG is located in a BWP in which the first RBG is located, and all PRBs of the second RBG overlap with the first subband.

In some embodiments, the indication information includes a mapping relationship in DCI, and the available PRBs in the first RBG is indicated according to the mapping relationship and a first element set, where the first element set includes: a corresponding relationship with the number of a plurality of available PRBs.

In some embodiments, the indication information includes bitmap information, and the bitmap information is used for indicating the available PRBs in the first RBG.

An executive body for the frequency domain resource determination method provided in the embodiment of this application may be a frequency domain resource determination apparatus. In the embodiment of this application, the frequency domain resource determination apparatus provided in the embodiment of this application is described by taking an example in which the frequency domain resource determination apparatus performs the frequency domain resource determination method.

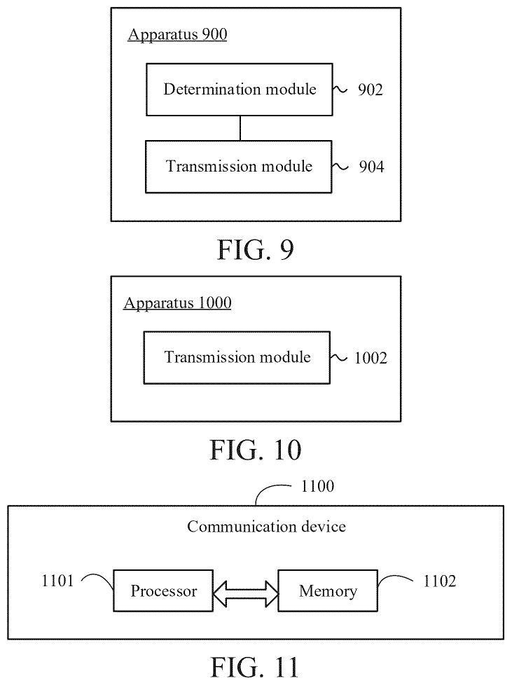

FIG. 9 is a schematic structural diagram of a frequency domain resource determination apparatus according to an embodiment of this application. The apparatus may correspond to a terminal in other embodiments. As shown in FIG. 9, an apparatus 900 includes the following module:
a determination module 902, configured to determine available PRBs in a first RBG in a first mode or a second mode, where at least one PRB in the first RBG overlaps with a first subband and/or a GB, and a transmission direction of the first subband is different from a transmission direction of the first RBG; the first mode includes: determining the available PRBs in the first RBG according to the first subband and/or the GB; and the second mode includes: determining the available PRBs in the first RBG according to indication information; and
a transmission module 904, configured to perform information transmission on the available PRBs in the first RBG, where the first RBG is configured or scheduled to the apparatus.

In the embodiment of this application, in a case that at least one PRB in the first RBG overlaps with the first subband and/or the GB and the transmission direction of the first subband is different from the transmission direction of the first RBG, the available PRBs in the first RBG may be determined according to the first subband and/or the GB or according to the indication information. In this way, the apparatus may perform information transmission on the available PRBs in the first RBG. In the embodiment of this application, the PRBs in the first RBG can be fully used, which is favorable for improving the utilization rate of frequency domain resources. In addition, in the embodiment of this application, the full-duplex configuration of different service requirements in an NR can be met, which is favorable for improving the system resource utilization rate and reducing the time delay.

In some embodiments, the determining the available PRBs in the first RBG according to the first subband and/or the GB includes: determining PRBs in the first RBG other than the PRBs that overlap with the first subband and/or the GB as the available PRBs.

In some embodiments, the indication information includes a first bit field, and the determination module 902 is further configured to determine the bit number of the first bit field according to the number of second RBGs, where the second RBG is located in a BWP in which the first RBG is located, and all PRBs of the second RBG overlap with the first subband.

In some embodiments, the number of available PRBs in the first RBG is less than or equal to the bit number of the first bit field, where one bit of the first bit field indicates one available PRB.

In some embodiments, the number of available PRBs in the first RBG is greater than the bit number of the first bit field, where one bit of the first bit field indicates X available PRBs, X is a positive integer, and X≥2.

In some embodiments, the first bit field further includes bit information for indicating X.

In some embodiments, the determination module 902 is configured to determine the bit number of the first bit field according to the number of second RBGs and the size of the GB.

In some embodiments, the indication information in DCI includes a mapping relationship, and the second mode includes: determining the available PRBs in the first RBG according to the mapping relationship and a first element set, where the first element set is configured by a network, where the first element set includes: a corresponding relationship with the number of a plurality of available PRBs.

In some embodiments, the indication information includes bitmap information, and the bitmap information is used for indicating the available PRBs in the first RBG.

In some embodiments, the transmission module 904 is further configured to receive UE specific signaling and/or UE common signaling, where the UE specific signaling and/or the UE common signaling are/is used for configuring the apparatus to use the first mode or the second mode according to the granularity of a slot or a sub-slot.

In some embodiments, the transmission module 904 is further configured to receive dynamic indication signaling, where the dynamic indication signaling is used for indicating the apparatus to determine the available PRBs in the first RBG in the first mode or the second mode, and the first RBG is located in a scheduled frequency domain resource.

In some embodiments, the determination module 902 is further configured to determine one of the following: (1) the frequency domain position and size of the first subband and the frequency domain position and size of the GB; or (2) the frequency domain position and size of the first subband and the size of the GB; and implicitly determine the frequency domain position and size of the GB according to the frequency domain position and size of the first subband.

For the apparatus 900 according to the embodiment of this application, refer to the processes corresponding to a method 200 in an embodiment of this application. In addition, units/modules in the apparatus 900 and other operations and/or functions described above are respectively intended to implement corresponding processes in the method 200, and the same or equivalent technical effects can be achieved. For the sake of simplicity, details are not described herein again.

The frequency domain resource determination apparatus in the embodiment of this application may be an electronic device, for example, an electronic device with an operating system, or may be a component in an electronic device, for example, an integrated circuit or a chip. The electronic device may be a terminal, or may be another device other than a terminal. Exemplarily, the terminal may include but is not limited to the types of the terminal 11 listed above, and the another device may be a server, a Network Attached Storage (NAS), or the like. This is not specifically limited in the embodiment of this application.

FIG. 10 is a schematic structural diagram of a frequency domain resource determination apparatus according to an embodiment of this application. The apparatus may correspond to a network side device in other embodiments. As shown in FIG. 10, an apparatus 1000 includes the following modules:

a transmission module 1002, configured to send indication information, where the indication information is used for indicating available PRBs in a first RBG, where at least one PRB in the first RBG overlaps with a first subband and/or a GB, and a transmission direction of the first subband is different from a transmission direction of the first RBG.

The transmission module 1004 is further configured to perform information transmission on the available PRBs in the first RBG, where the first RBG is configured or scheduled to the terminal.

In some embodiments, the apparatus further includes a processing module.

In the embodiment of this application, in a case that at least one PRB in the first RBG overlaps with the first subband and/or the GB and the transmission direction of the first subband is different from the transmission direction of the first RBG, the apparatus may indicate the available PRBs in the first RBG, or may perform information transmission on the available PRBs in the first RBG. In the embodiment of this application, the PRBs in the first RBG can be fully used, which is favorable for improving the utilization rate of frequency domain resources. In addition, in the embodiment of this application, the full-duplex configuration of different service requirements in an NR can be met, which is favorable for improving the system resource utilization rate and reducing the time delay.

In some embodiments, the indication information includes a first bit field, and the bit number of the first bit field is determined according to the number of second RBGs, where the second RBG is located in a BWP in which the first RBG is located, and all PRBs of the second RBG overlap with the first subband.

In some embodiments, the indication information includes a mapping relationship, and the available PRBs in the first RBG is indicated according to the mapping relationship and a first element set, where the first element set includes: a corresponding relationship with the number of a plurality of available PRBs.

In some embodiments, the indication information includes bitmap information in DCI, and the bitmap information is used for indicating the available PRBs in the first RBG.

For the apparatus 1000 according to the embodiment of this application, refer to the processes corresponding to a method 800 in an embodiment of this application. In addition, units/modules in the apparatus 1000 and other operations and/or functions described above are respectively intended to implement corresponding processes in the method 800, and the same or equivalent technical effects can be achieved. For the sake of simplicity, details are not described herein again.

The frequency domain resource determination apparatus provided in the embodiment of this application can implement various processes implemented in the method embodiments in FIG. 2 to FIG. 8, and the same technical effects can be achieved. To avoid repetition, details are not described herein again.

As shown in FIG. 11, an embodiment of this application further provides a communication device 1100, including a processor 1101 and a memory 1102. The memory 1102 stores a program or an instruction runnable on the processor 1101. For example, when the communication device 1100 is a terminal, the program or instruction, when executed by the processor 1101, implements the steps of the frequency domain resource determination method embodiment described above, and the same technical effects can be achieved. When the communication device 1100 is a network side device, the program or instruction, when executed by the processor 1101, implements the steps of the frequency domain resource determination method embodiment described above, and the same technical effects can be achieved. To avoid repetition, details are not described herein again.

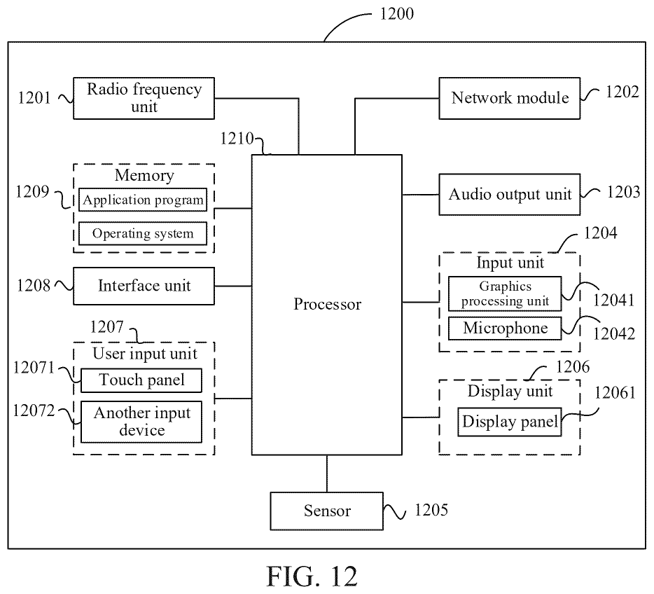

An embodiment of this application further provides a terminal, including a processor and a communication interface. The processor is configured to determine available PRBs in a first RBG in a first mode or a second mode, where at least one PRB in the first RBG overlaps with a first subband and/or a GB, and a transmission direction of the first subband is different from a transmission direction of the first RBG; the first mode includes: determining the available PRBs in the first RBG according to the first subband and/or the GB; and the second mode includes: determining the available PRBs in the first RBG according to indication information, where the communication interface is configured to perform information transmission on the available PRBs in the first RBG, where the first RBG is configured or scheduled to the terminal. This terminal embodiment is corresponding to the terminal-side method embodiment described above. Each implementation process and implementation of the method embodiment described above may be applied to this terminal embodiment, and the same technical effects can be achieved. FIG. 12 is a schematic diagram of hardware structures of a terminal for implementing an embodiment of this application.

The terminal 1200 includes but is not limited to: at least part of components such as a radio frequency unit 1201, a network module 1202, an audio output unit 1203, an input unit 1204, a sensor 1205, a display unit 1206, a user input unit 1207, an interface unit 1208, a memory 1209 and a processor 1210.

Those skilled in the art can understand that the terminal 1200 may further include a power supply (for example, a battery) for supplying power to the components. The power supply may be logically connected to the processor 1210 by a power management system, thereby implementing functions such as charging, discharging and power consumption management by the power management system. The terminal structures shown in FIG. 12 do not constitute a limitation on the terminal, and the terminal may include more or fewer components than those shown in figures, or some components may be combined, or different component layouts may be used. Details are not described herein.

It should be understood that in the embodiment of this application, the input unit 1204 may include a Graphics Processing Unit (GPU) 12041 and a microphone 12042. The graphics processing unit 12041 processes image data of a static picture or a video that is obtained by an image capture apparatus (for example, a camera) in a video capture mode or an image capture mode. The display unit 1206 may include a display panel 12061. The display panel 12061 may be configured by using a liquid crystal display, an organic light-emitting diode, or the like. The user input unit 1207 includes at least one of a touch panel 12071 or another input device 12072. The touch panel 12071 is also referred to as a touch screen. The touch panel 12071 may include two parts: a touch detection apparatus and a touch controller. The another input device 12072 may include, but not limited to, a physical keyboard, a functional key (for example, a volume control key or a switch key), a track ball, a mouse, and a joystick, which are not described herein in detail.

In the embodiment of this application, after receiving downlink data from a network side device, the radio frequency unit 1201 may transmit the downlink data to the processor 1210 for processing. In addition, the radio frequency unit 1201 may send uplink data to the network side device. Generally, the radio frequency unit 1201 includes, but is not limited to, an antenna, an amplifier, a transceiver, a coupler, a low noise amplifier, a duplexer, and the like.

The memory 1209 may be configured to store a software program or instruction and various data. The memory 1209 may mainly include a first storage area for storing a program or an instruction and a second storage area for storing data. The first storage area may store an operating system, an application program or instruction (for example, an audio play function or an image play function) required by at least one function, and the like. In addition, the memory 1209 may include a volatile memory or a non-volatile memory, or the memory 1209 may include both a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synchlink DRAM (SLDRAM), or a Direct Rambus RAM (DRRAM). The memory 1209 in the embodiment of this application includes, but is not limited to, these memories and any other suitable types of memories.

The processor 1210 may include one or more processing units. In some embodiments, the processor 1210 integrates an application processor and a modem processor. The application processor mainly processes operations related to an operating system, a user interface, an application program, and the like. The modem processor mainly processes wireless communication signals, for example, a baseband processor. It can be understood that the modem processor described above may not be integrated into the processor 1210.

The processor 1210 may be configured to determine available PRBs in a first RBG in a first mode or a second mode, where at least one PRB in the first RBG overlaps with a first subband and/or a GB, and a transmission direction of the first subband is different from a transmission direction of the first RBG; the first mode includes: determining the available PRBs in the first RBG according to the first subband and/or the GB; and the second mode includes: determining the available PRBs in the first RBG according to indication information. The radio frequency unit 1201 may be configured to perform information transmission on the available PRBs in the first RBG, where the first RBG is configured or scheduled to the terminal.

In the embodiment of this application, in a case that at least one PRB in the first RBG overlaps with the first subband and/or the GB and the transmission direction of the first subband is different from the transmission direction of the first RBG, the terminal may determine the available PRBs in the first RBG according to the first subband and/or the GB or according to the indication information. In this way, the terminal may perform information transmission on the available PRBs in the first RBG. In the embodiment of this application, the PRBs in the first RBG can be fully used, which is favorable for improving the utilization rate of frequency domain resources. In addition, in the embodiment of this application, the full-duplex configuration of different service requirements in an NR can be met, which is favorable for improving the system resource utilization rate and reducing the time delay.

The terminal 1200 provided in the embodiment of this application may further implement the processes in the frequency domain resource determination method embodiment described above, and the same technical effects can be achieved. To avoid repetition, details are not described herein again.

An embodiment of this application further provides a network side device, including a processor and a communication interface. The communication interface is configured to send indication information. The indication information is used for indicating an available PRBs in a first RBG, where at least one PRB in the first RBG overlaps with a first subband and/or a GB, and a transmission direction of the first subband is different from a transmission direction of the first RBG. The network side device performs information transmission on the available PRBs in the first RBG, where the first RBG is configured or scheduled to the terminal. This network side device embodiment corresponds to the network side device method embodiment described above. The implementation processes and implementations in the method embodiment described above all may be applied to this network side device embodiment, and the same technical effects can be achieved.

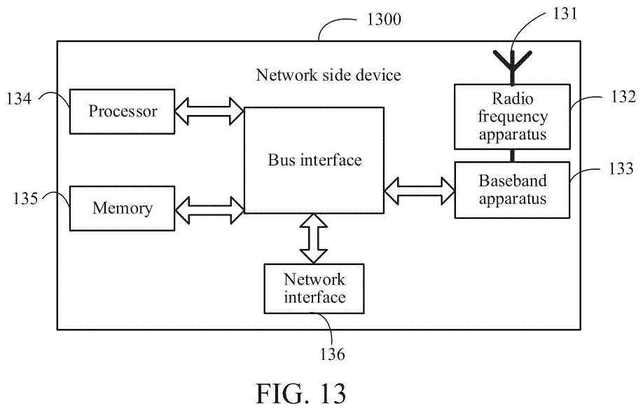

Embodiments of this application further provide a network side device. As shown in FIG. 13, the network side device 1300 includes: an antenna 131, a radio frequency apparatus 132, a baseband apparatus 133, a processor 134, and a memory 135. The antenna 131 is connected to the radio frequency apparatus 132. In an uplink direction, the radio frequency apparatus 132 receives information through the antenna 131, and sends the received information to the baseband apparatus 133 for processing. In a downlink direction, the baseband apparatus 133 processes the information to be transmitted, and sends the information to the radio frequency apparatus 132; and the radio frequency apparatus 132 processes the received information, and then sends the information through the antenna 131.

The method performed by the network side device in the embodiment described above may be implemented in the baseband apparatus 133. The baseband apparatus 133 includes a baseband processor.

The baseband apparatus 133 may include, for example, at least one baseband board, and a plurality of chips are arranged on the baseband board. As shown in FIG. 13, one chip is, for example, the baseband processor, which is connected to the memory 135 through a bus interface, so as to call a program in the memory 135 to perform an operation of the network device shown in the method embodiment described above.

The network side device may further include a network interface 136. The interface is, for example, a common public radio interface (CPRI).

The network side device 1300 in embodiments of this application further includes: an instruction or a program stored on the memory 135 and runnable on the processor 134. The processor 134 calls the instruction or program in the memory 135 to perform the method performed by each module shown in FIG. 10, and the same technical effects can be achieved. To avoid repetition, details are not described herein again.

An embodiment of this application further provides a readable storage medium. The readable storage medium stores a program or an instruction. When the program or instruction is executed by a processor, various processes of the frequency domain resource determination method embodiments described above are implemented, and the same technical effects can be achieved. To avoid repetition, details are not described herein again.

The processor may be a processor in the terminal in the embodiments described above. The readable storage medium may be non-volatile or non-transient. The readable storage medium includes a computer-readable storage medium, for example, a computer read-only memory (ROM), a random access memory (RAM), a magnetic disk, an optical disc, or the like.

An embodiment of this application further provides a chip. The chip includes a processor and a communication interface. The communication interface is coupled to the processor. The processor is configured to run a program or an instruction to implement various processes of the frequency domain resource determination method embodiments described above, and the same technical effects can be achieved. To avoid repetition, details are not described herein again.

It should be understood that the chip mentioned in the embodiment of this application may also be referred to as a system level chip, a system chip, a chip system, an on-chip system chip, or the like.

An embodiment of this application further provides a computer program/program product. The computer program/program product is stored in a storage medium. The computer program/program product is executed by at least one processor to implement various processes of the frequency domain resource determination method embodiments described above, and the same technical effects can be achieved. To avoid repetition, details are not described herein again.

An embodiment of this application further provides a frequency domain resource determination system, including: a terminal and a network side device. The terminal may be configured to perform the steps of the frequency domain resource determination method described above. The network side device may be configured to perform the steps of the frequency domain resource determination method described above.

It should be noted that the terms “include”, “comprise”, or any other variants thereof in this specification are intended to cover a non-exclusive inclusion, so that a process, method, article, or apparatus including a series of elements not only includes those elements, but also includes other elements that are not explicitly listed, or also includes elements inherent to such process, method, article, or apparatus. Without more restrictions, the elements defined by the sentence “including a . . . ” or “comprising a” do not exclude the existence of other identical elements in the process, method, article, or apparatus including the elements. Moreover, it should be noted that the scope of the method and apparatus in the implementations of this application is not limited to executing the functions in the sequence shown or discussed, but may include executing the functions in a substantially concurrent mode or in a reverse sequence depending on the related functions. For example, the method described may be performed in an order different from that described, and various steps may be further added, omitted, or combined. Moreover, features described with reference to some examples may be combined in other examples.

Through the descriptions in the foregoing implementations, those skilled in the art can clearly understand that the methods in the foregoing embodiments may be implemented by means of software and a necessary general hardware platform, and of course, may also be implemented by hardware. However, in many cases, the former is the better implementation. Based on such an understanding, the technical solutions in this application essentially, or the part contributing to the prior art, may be embodied in the form of a computer software product. The computer software product is stored in a storage medium (for example, an ROM/RAM, a magnetic disk, or an optical disc), including several instructions to enable a terminal (which may be a mobile phone, a computer, a server, an air conditioner, a network device, or the like) to perform the method according to each embodiment of this application.

The embodiments of this application are described above with reference to the accompanying drawings. However, this application is not limited to the foregoing specific implementations. The foregoing specific implementations are merely illustrative rather than restrictive. Those of ordinary skill in the art can make various variations under the inspiration of this application without departing from the spirit of this application and the protection scope of the claims, and all these variations shall fall within the protection scope of this application.

What is claimed is:

1. A method for frequency domain resource determination, comprising:
determining, by a terminal, available physical resource blocks (PRBs) in a first resource block group (RBG) in a first mode or a second mode, wherein at least one PRB in the first RBG overlaps with a first subband or a guard band (GB), and a transmission direction of the first subband is different from a transmission direction of the first RBG; the first mode comprises: determining the available PRBs in the first RBG according to the first subband or the GB; and the second mode comprises: determining the available PRBs in the first RBG according to indication information; and
performing, by the terminal, information transmission on the available PRBs in the first RBG, wherein the first RBG is configured or scheduled to the terminal.

2. The method according to claim 1, wherein before the determining, by a terminal, available PRBs in a first RBG in a first mode or a second mode, the method further comprises one of the following:
determining, by the terminal, one of the following: a frequency domain position and size of the first subband and a frequency domain position and size of the GB; or the frequency domain position and size of the first subband and the size of the GB; or
implicitly determining, by the terminal, the frequency domain position and size of the GB according to the frequency domain position and size of the first subband configured by a network side device.

3. The method according to claim 1, wherein the determining the available PRBs in the first RBG according to the first subband or the GB comprises: determining PRBs in the first RBG other than the PRBs that overlap with the first subband or the GB as the available PRBs.

4. The method according to claim 1, wherein the indication information comprises a first bit field, and the method further comprises:
determining, by the terminal, a bit number of the first bit field according to a number of second RBGs, wherein the second RBG locates in a bandwidth part (BWP) in which the first RBG is located, and all PRBs of the second RBG overlap with the first subband.

5. The method according to claim 4, wherein:
a number of available PRBs in the first RBG is less than or equal to the bit number of the first bit field, wherein one bit of the first bit field indicates one available PRB; or
the number of available PRBs in the first RBG is greater than the bit number of the first bit field, wherein one bit of the first bit field indicates X available PRBs, X is a positive integer, and X≥2.

6. The method according to claim 4, wherein the determining, by the terminal, the bit number of the first bit field according to the number of second RBGs comprises:
determining, by the terminal, the bit number of the first bit field according to the number of second RBGs and the size of the GB.

7. The method according to claim 1, wherein the indication information in downlink control information (DCI) comprises a mapping relationship, and the second mode comprises: determining the available PRBs in the first RBG according to the mapping relationship and a first element set, wherein the first element set is configured by a network,
wherein the first element set comprises: a corresponding relationship between each element in the first element set and a number of the available PRBs.

8. The method according to claim 1, further comprising:
receiving, by the terminal, user equipment (UE) specific signaling or UE common signaling, wherein the UE specific signaling or the UE common signaling is used for configuring the terminal to use the first mode or the second mode according to a granularity of a slot or a sub-slot.

9. The method according to claim 1, further comprising: receiving, by the terminal, dynamic indication signaling, wherein the dynamic indication signaling is used for indicating the terminal to determine the available PRBs in the first RBG in the first mode or the second mode, and the first RBG is located in a scheduled frequency domain resource.

10. A method for frequency domain resource determination, comprising:
sending, by a network side device, indication information, wherein the indication information is used for indicating available physical resource blocks (PRBs) in a first resource block group (RBG), wherein at least one PRB in the first RBG overlaps with a first subband or a guard band (GB), and a transmission direction of the first subband is different from a transmission direction of the first RBG; and
performing, by the network side device, information transmission on the available PRBs in the first RBG, wherein the first RBG is configured or scheduled to a terminal.

11. The method according to claim 10, wherein the indication information comprises a first bit field, and a bit number of the first bit field is determined according to a number of second RBGs, wherein the second RBG is located in a bandwidth part (BWP) in which the first RBG is located, and all PRBs of the second RBG overlap with the first subband.

12. The method according to claim 10, wherein the indication information comprises a mapping relationship in downlink control information (DCI), and the available PRBs in the first RBG are indicated according to the mapping relationship and a first element set,
wherein the first element set comprises: a corresponding relationship between each element in the first element set and a number of the available PRBs.

13. The method according to claim 10, wherein the indication information comprises bitmap information, and the bitmap information is used for indicating the available PRBs in the first RBG.

14. A terminal, comprising a memory storing a computer program; and a processor coupled to the memory and configured to execute the computer program to perform operations comprising:
determining available physical resource blocks (PRBs) in a first resource block group (RBG) in a first mode or a second mode, wherein at least one PRB in the first RBG overlaps with a first subband or a guard band (GB), and a transmission direction of the first subband is different from a transmission direction of the first RBG; the first mode comprises: determining the available PRBs in the first RBG according to the first subband or the GB; and the second mode comprises: determining the available PRBs in the first RBG according to indication information; and
performing information transmission on the available PRBs in the first RBG, wherein the first RBG is configured or scheduled to the terminal.

15. The terminal according to claim 14, wherein before the determining available PRBs in a first RBG in a first mode or a second mode, the operations further comprise one of the following:
determining one of the following: a frequency domain position and size of the first subband and a frequency domain position and size of the GB; or the frequency domain position and size of the first subband and the size of the GB; or
implicitly determining the frequency domain position and size of the GB according to the frequency domain position and size of the first subband configured by a network side device.

16. The terminal according to claim 14, wherein the determining the available PRBs in the first RBG according to the first subband or the GB comprises: determining PRBs in the first RBG other than the PRBs that overlap with the first subband or the GB as the available PRBs.

17. The terminal according to claim 14, wherein the indication information comprises a first bit field, and the operations further comprise:
determining a bit number of the first bit field according to a number of second RBGs, wherein the second RBG locates in a bandwidth part (BWP) in which the first RBG is located, and all PRBs of the second RBG overlap with the first subband.

18. The terminal according to claim 17, wherein:
a number of available PRBs in the first RBG is less than or equal to the bit number of the first bit field, wherein one bit of the first bit field indicates one available PRB; or
the number of available PRBs in the first RBG is greater than the bit number of the first bit field, wherein one bit of the first bit field indicates X available PRBs, X is a positive integer, and X≥2.

19. The terminal according to claim 17, wherein the determining the bit number of the first bit field according to the number of second RBGs comprises:
determining the bit number of the first bit field according to the number of second RBGs and the size of the GB.

20. The terminal according to claim 14, wherein the indication information in downlink control information (DCI) comprises a mapping relationship, and the second mode comprises: determining the available PRBs in the first RBG according to the mapping relationship and a first element set, wherein the first element set is configured by a network,
wherein the first element set comprises: a corresponding relationship between each element in the first element set and a number of the available PRBs.
